(19) United States
(12) Patent Application Publication
(10) Pub. No.: US 2014/0326847 A1
(43) Pub. Date: Nov. 6, 2014

(54) Magnetic Tablet Computer Stand

(71) Applicant: Charles Galley Barr, Deerfield Beach, FL (US)

(72) Inventor: Charles Galley Barr, Deerfield Beach, FL (US)

(21) Appl. No.: 14/215,260

(22) Filed: Mar. 17, 2014

Related U.S. Application Data
(60) Provisional application No. 61/819,411, filed on May 3, 2013.

(51) Int. Cl. F16M 11/04

(52) U.S. Cl. CPC F16M 11/04
USPC 248/455

(57) ABSTRACT

The invention is a stand for anchoring a tablet, phone, GPS or other device at a user configured optimal viewing angle using shape, gravity and friction to anchor to multiple planes. The planes can be upper or outer surfaces, objects or structures. The proximal end of the rode length has a flange to hold the device in a position for hands-free use at an optimal viewing angle. A plurality of rode lengths can be used for increased stability. The distal end of the rode length may have a foot or other additions for increased stability.

### CROSS-REFERENCE TO RELATED APPLICATIONS

This application claims priority to U.S. Provisional patent application No. 61/819,411 entitled “Magnetic Tablet Computer Stand” filed on May 3, 2013, which provisional application is incorporated herein by reference in its entirety; this application claims the benefit of the provisional's filing date under 35 U.S.C. 119(e).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention is a stand for anchoring tablets, phones, GPS or other devices at a user configured optimal viewing angle using shape, gravity and friction to anchor to multiple planes. The planes can be upper or outer surfaces, objects or structures.

| | Issue or | |
|---|---|---|
| Publication Number | Publication Date | Inventor |
| USD674805 S1 | Jan. 22, 2013 | Allan R. Vincent |
| US20130048802 A1 | Feb. 28, 2013 | Iles Z. Guran |
| US20120252543 A1 | Oct. 4, 2012 | Richard Cho |
| US20120280009 A1 | Nov. 8, 2012 | Tracy V. Carroll |
| U.S. Pat. No. 8,230,992 B2 | Jul. 31, 2012 | David John Law |
| US20110292666A1 | Jul. 8, 2010 | Kenneth John Gallagher |
| US20120187257A1 | Jul. 26, 2012 | Jianha Zou |
| U.S. Pat. No. 7,922,137B2 | Aug. 23, 2006 | Bradley A. Derry |

Prior arts stands when used for objects such as tablet computers or smart phones are typically designed to rest on flat horizontal surfaces, such as tables, desks, or floors. Tablet computer and smart phone users often use their device in more casual settings, such as on the sofa, or in bed. Due to the design of the prior art stands, users are forced to physically hold their device, placing stress on the neck, back, arms, hands, and wrists and inhibiting two-handed use. Further, placing tablet computers on pillows, or resting on user's bodies also results in uncomfortable viewing and unhealthy postures.

### BRIEF SUMMARY OF THE INVENTION

The invention is a stand for anchoring tablets, phones, GPS or other devices at a user configured optimal viewing angle using shape, gravity and friction to anchor to multiple planes. The planes can be upper or outer surfaces, objects or structures.

The invention does not use traditional legs that require a single plane and even or level surfaces but rather uses ‘rode lengths’ more like an anchor and cable combination so the device being stood can be positioned at a user configured optimal viewing angle using shape, gravity, and friction to anchor to surfaces, objects, or structures.

### BRIEF DESCRIPTION OF THE SEVERAL VIEWS OF THE DRAWING

FIG. 1 is a single rode length stand using shape, gravity and friction to rest on surface.

FIG. 2 is a dual rode length stand with a user configured optimal viewing angle using shape, gravity, and friction to anchor to the legs of a desk and other desk surfaces.

FIG. 3 is a dual rode length stand with a user configured optimal viewing angle using shape, gravity and friction to anchor between cushions on a sofa.

FIG. 4 shows a stand supporting an object using shape, gravity and friction.

FIG. 5 shows a stand suspended from a structure using shape, gravity and friction.

FIG. 6 shows a stand suspended from a person's body with hands-free use at a user configured optimal viewing angle using shape, gravity and friction.

### DETAILED DESCRIPTION OF THE INVENTION

The invention is a stand for anchoring tablets, phones, GPS or other devices at a user configured optimal viewing angle using shape, gravity and friction to anchor to multiple planes. The planes can be upper or outer surfaces, objects or structures.

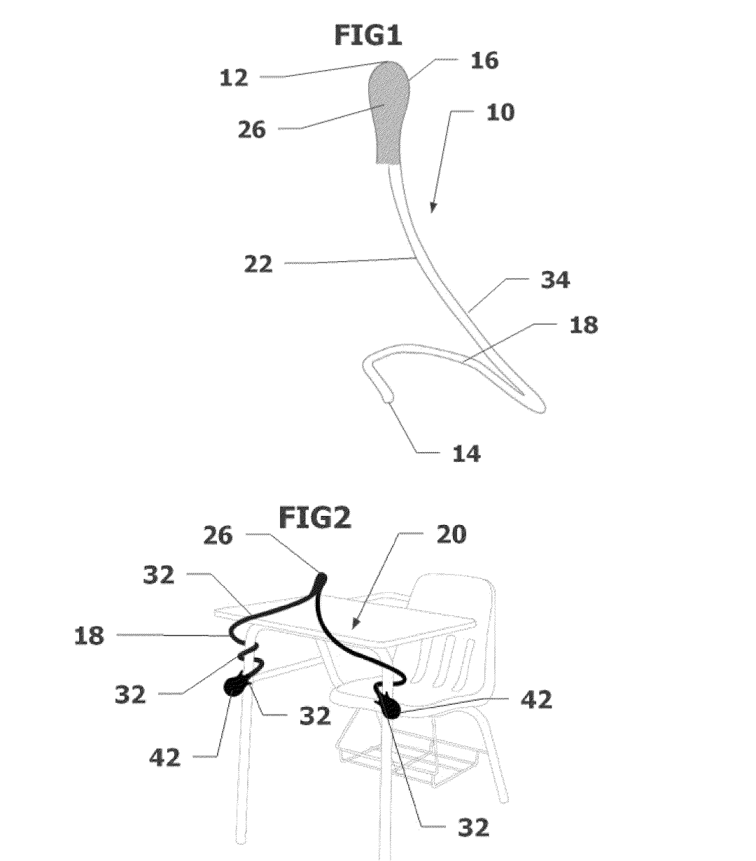

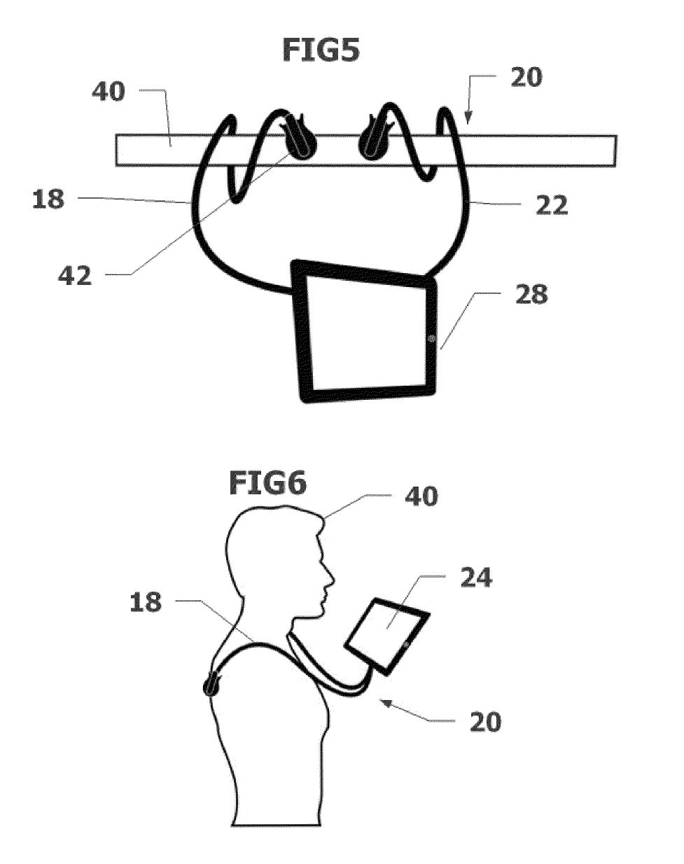

The invention is comprised of a single rode length stand 10 as shown in FIG. 1 or a plurality of rode lengths 22. (Dual length stands shown in FIG 2.-FIG. 6.)

The ability to anchor using rode length 22 to create a supporting shape 18 with multiple resting points 32 where the resting points 32 may be on different planes for more casual use is an improvement over prior art that requires even surfaces.

The term ‘rode length’ is used to indicate that the invention has some characteristics like an anchor and cable to adjust the position of the stand in multiple planes as opposed to the traditional prior art characteristics of a stand with fixed length and fixed angle legs that must sit on an even surface. A single rode length may be sufficient (as shown in FIG. 1) for resting on a surface. A plurality of rode lengths may be used for more stability.

The term ‘user configured optimal viewing angle’ is used to indicate that the invention can be used to change the position of the tablet, phone, GPS or other device being held in three different planes using shape, gravity and friction to meet the user's best angle and distance for the particular use. A user may choose a different combination of shape, gravity and friction for watching a movie on a tablet than reading an electronic book allowing the user to broaden the use of the tablet without uncomfortable viewing and unhealthy postures.

A resting configuration of the invention is a stand 10 comprising a rode length 22 of semi-rigid flexible material 34 with a proximal end 12, a distal end 14, where the rode length 22 is curved and fixed by a user into a supporting shape 18 with a plurality of resting points 32 that use shape, gravity and friction to rest on an outer or upper surface 36, and holds the proximal end 12 of the rode length 22 with a flange 26 affixed to the proximal end 12 to retain an object 28 at a user configured optimal viewing angle 24. The distal end may have feet 42 for additional stability. The flange 26 and the feet 42 are affixed by means known in the art.

The flange 26 may be a sticky pad, a magnet 16 or other anchoring means. The flange 26 may be affixed to one rode length 22 or a plurality of rode lengths.

The object 28 that is positioned by the invention may be a tablet computer, a GPS, a cell phone, some other type of mobile computing device or some other object 28 such as a book or music.

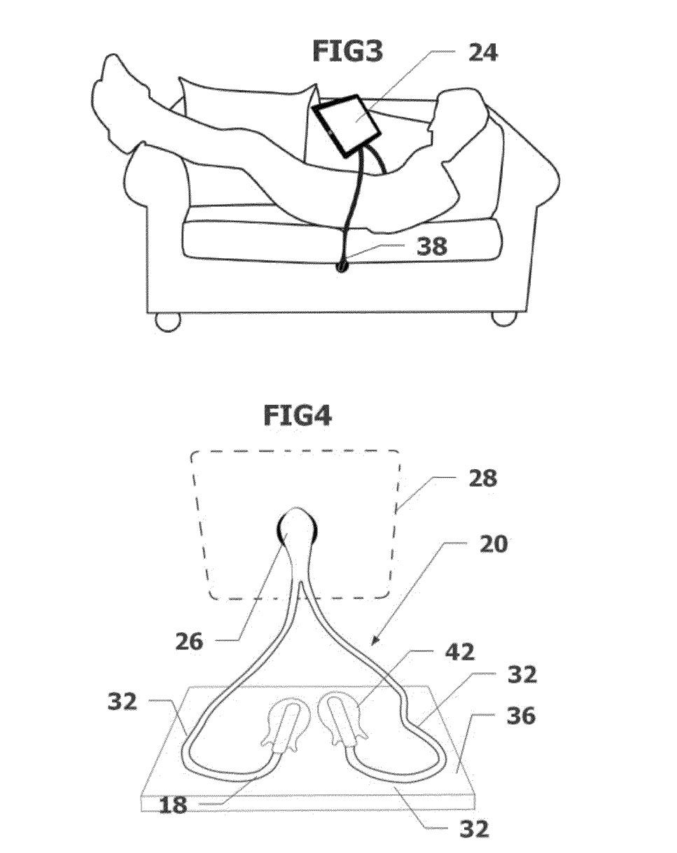

A wedged configuration (anchored between objects) is a stand 10 comprising a rode length 22 of semi-rigid flexible material 34 with a proximal end 12 and a distal end 14 that anchors between objects 38 using shape, gravity and friction where the rode length 22 is curved and fixed by a user into a supporting shape 18 that suspends the proximal end 12 of the rode length with a flange 26 affixed to the proximal end to retain an Object at a user configured optimal viewing angle 24. FIG. 3 shows the invention anchored between cushions on a couch.

A suspended configuration is a stand 10 that comprises a rode length 22 of semi-rigid flexible material 34, with a proximal end 12, a distal end 14 that anchors to a structure 40 using shape, gravity and friction, where the rode length 22 is curved by a user into a supporting shape 18 that suspends the proximal end 12 of the rode length with a flange 26 anchored to the proximal end 12 to retain an object 28 at a user configured optimal viewing angle 24.

Parts of the supporting shape may be hung from a structure (FIG. 5 and FIG. 6) or anchored onto objects (see FIG. 2) or between objects (FIG. 3).

The invention with multiple rode lengths 22 may have one rode length 22 resting on a surface and the other rode length 22 wedged between objects like FIG. 3.

The above disclosure is sufficient to enable one of ordinary skill in the art to practice the invention, and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

What is claimed is:

1. A stand comprising:
a rode length of semi-rigid flexible material with
a proximal end,
a distal end, where
the rode length is curved and fixed by a user into
a supporting shape with a plurality of resting points that uses shape, gravity and friction to rest on a surface, where
a flange affixed to the proximal end to retains an object where
the object is positioned for hands-free use at
a user configured optimal viewing angle.

2. The stand of claim 1 where the flange is a sticky pad.

3. The stand of claim 1 where the flange is a magnet.

4. The stand of claim 1 where the flange is affixed to a plurality of rode lengths of semi-rigid flexible material joined together at the flange.

5. The stand of claim 1 where the object is a tablet computer.

6. The stand of claim 1 where the object is held in place by contours in the rode length such as using the invention to hold paper documents such as music or hooks.

7. The stand of claim 1 where a foot is attached to the distal end.

8. A stand comprising:
a rode length of semi-rigid flexible material with
a proximal end and
a distal end where
the rode length is curved by a user into
a supporting shape that wedges between objects using shape, gravity and friction, with
a flange affixed to the proximal end that retains an object where
the object is positioned for hands-free use at an optimal viewing angle.

9. The stand of claim 8 where a foot is attached to the distal end.

10. A stand that comprises:
a rode length of semi-rigid flexible material, with,
a proximal end, where
the rode length is curved by a user into
a supporting shape that suspends using shape, gravity and friction, where
the proximal end of the rode length with
a flange affixed to the proximal end to retains an object where
the object is positioned for hands-free use at an optimal viewing angle.

11. The stand of claim 10 where a foot is attached to the distal end.

12. The stand of claim 10 where the structure is a human body part.

13. The stand of claim 10 where the structure is a car interior part.

14. The stand of claim 10 where the structure is a piece of furniture such as a chair.

15. The stand of claim 10 where the structure is a piece of equipment such as a treadmill or other exercise device.

16. The stand of claim 10 where the structure is a mobile structure, such as a stroller.
